(19) United States
(12) Patent Application Publication
(10) Pub. No.: US 2010/0298454 A1
(43) Pub. Date: Nov. 25, 2010

(54) FLAME RETARDED FLEXIBLE POLYURETHANE FOAMS AND FLEXIBLE POLYURETHANE FOAM FORMULATIONS

(75) Inventors: Hoover B. Chew, Summerville, SC (US); Ravindra R> Joshi, Stevenson Ranch, CA (US); Arthur G. Mack, Prairieville, LA (US)

Correspondence Address: ALBEMARLE CORPORATION;PATENT DEPARTMENT, 451 FLORIDA STREET, BATON ROUGE, LA, 70801, US

(73) Assignee: Albemarle Corporation

(21) Appl. No.: 12/672,458

(22) PCT Filed: Aug. 6, 2008
(86) PCT No.: PCT/US08/72333

§ 371 Date: Feb. 5, 2010

Related U.S. Application Data
(60) Provisional application No. 60/954,505, filed on Aug. 7, 2007.

(51) Int. Cl. C08K 5/521; C09K 21/12

(52) U.S. Cl. 521/108; 252/609; 521/107

(57) ABSTRACT

The present invention relates to flame retarded flexible polyurethane foam formulations, flame retardant additives suitable for use therein, and flame retarded foams made therefrom.

### FIELD OF THE INVENTION

The present invention relates to flame retarded polyurethane foam formulations, flame retardant additives suitable for use therein, and flame retarded foams made therefrom.

### BACKGROUND OF THE INVENTION

Flexible polyurethane foams are used in many applications today. Because of the widespread use of flexible polyurethane foams, much research has been done on providing flame retardancy to such foams. To this end, a myriad of flame retardants have been used and proposed to provide flame retardant properties to flexible polyurethane foams. However, even with the available flame retardantsm the industry has increasingly requested flame retardants that outperform or have more favorable characteristics than those currently available.

### SUMMARY OF THE INVENTION

The present invention relates to a flexible polyurethane foam formulation comprising a) at least one, in some embodiments only one, phosphorous-containing flame retardant; and b) at least one, in some embodiments only one, alkylated triaryl phosphate ester, preferably isopropylphenyl diphenyl phosphate; c) at least one, in some embodiments only one, i) isocyanate; ii) polyol, or combinations of i) and ii); and d) at least one, in some embodiments only one, blowing agent, wherein a) is present in an amount of less than about 30 wt. %, based on the total weight of a) and b), and b) is present in an amount of greater than about 70 wt. %, based on the total weight of a) and b).

The present invention also relates to a process for forming a flexible flame retarded polyurethane foam comprising combining or bringing together a) at least one, in some embodiments only one, phosphorous-containing flame retardant; and b) at least one, in some embodiments only one, alkylated triaryl phosphate ester, preferably isopropylphenyl diphenyl phosphate; c) at least one, in some embodiments only one, i) isocyanate; ii) polyol, or combinations of i) and ii); and d) at least one, in some embodiments only one, blowing agent, in the presence of at least one, in some embodiments only one, catalyst, wherein a) is present in an amount of less than about 30 wt. %, based on the total weight of a) and b), and b) is present in an amount of greater than about 70 wt. %, based on the total weight of a) and b), and wherein the flame retarded flexible polyurethane foam thus formed meets or exceeds the requirements of California Technical Bulletin 117 part A and D.

### DETAILED DESCRIPTION OF THE INVENTION

The inventors hereof have discovered that the use of the flame retardant additives described herein, can provide rigid flame retarded polyurethane foams that meet or exceeds the requirements of California Technical Bulletin 117 part A and D.

### Flame Retardant Additive

The flame retardant additives of the present invention comprise a) at least one, in some embodiments only one, phosphorous-containing flame retardant; and b) at least one, in some embodiments only one, alkylated triaryl phosphate ester.

Generally, the flame retardant additives of the present invention contain less than about 30 wt. %, typically in the range of from about 1 to about 30 wt. %, of a) and greater than about 70 wt. %, typically in the range of from about 70 to about 99 wt. %, of b), all based on the total weight of the flame retardant additive. In some embodiments, the flame retardant additives of the present invention contain in the range of from about 5 to about 30 wt. % of a) and in the range of from about 70 to about 95 wt. % of b). In an exemplary embodiment, the flame retardant additives of the present invention contain in the range of from about 5 to about 15 wt. % of a) and in the range of from about 85 to about 95 wt. % of b).

The flame retardant additives of the present invention can be characterized as having a phosphorus content in the range of from about 5 to about 15 wt. %, based on the total weight of the flame retardant additive. In some embodiments, the flame retardant additives of the present invention can be characterized as having a phosphorus content in the range of from about 8 to about 15 wt. %, preferably in the range of from about 8 to about 12 wt. %, both on the same basis.

The flame retardant additives of the present invention can also be characterized as having a viscosity at 25° C. in the range of from about 100 to about 2000 cP. In some embodiments, the flame retardant additives of the present invention can be characterized as having a viscosity in the range of from about 100 to about 1000 cP, preferably in the range of from about 400 to about 600 cP. The low viscosity of the present flame retardant additives make the especially effective in flexible foam formulations because the low viscosity allows for better dispersion in the flexible foam formulations, thus allowing for more effective foams. For example, a poorly dispersed flame retardant could negatively effect the mechanical properties of the foam, as is well-known in the art.

The inventors hereof have unexpectedly discovered that by utilizing levels of a) as low as described above, flame retarded flexible polyurethane foams that meet or exceeds the requirements of California Technical Bulletin 117 part A and D can be provided. This is a desirable quality because, among other things, phosphorous-containing flame retardants currently used in polyurethane, which can be used in some embodiments of the present invention, are considered chemical weapons precursors, thus their shipping, use, etc., and distribution could prove problematic and expensive. However, the inventors hereof have discovered that phosphorous-containing flame retardant levels within the above described ranges, in some embodiments in the range of from about 5 to about 15 wt. %, alleviates some of the problems associated with having a component of the flame retardant additive considered a chemical weapons precursor. While heretofore levels within this range were not contemplated, the inventors hereof have unexpectedly discovered that phosphorous-containing flame retardant levels within these ranges can still provide for flame retarded polyurethane foams that meet or exceeds the requirements of California Technical Bulletin 117 part A and D.

### Component a)

The phosphorous-containing flame retardant used herein can be selected from any phosphorous flame retardant, preferably those phosphorous flame retardants having a phosphorous content, as determined by P-NMR or ICP, in the range of from about 10 to about 30 wt. %, preferably in the range of from about 15 to about 25 wt. %, more preferably in the range of from about 18 to about 21 wt. %, all based on the total weight of the phosphorous flame retardant. In some embodiments, the phosphorous-containing flame retardant is a phosphate, in other embodiments a phosphite, and in still other embodiments, a phosphonate. The phosphorus-containing flame retardant can be cyclic or linear, preferably cyclic. In an exemplary embodiment, the phosphorous-containing flame retardant used herein is a cyclic phosphonate. In some embodiments, the cyclic phosphonate contains at least dimers and monomers, typically in the range of from about 50 to about 70 wt. % monomer and in the range of from about 15 to about 25 wt. % dimer, both based on the total weight of the cyclic phosphonate. In these embodiments, the remainder of the cyclic phosphonate is typically trimers, etc. that have a higher molecular weight than the dimers. In preferred embodiments, the monomers are CAS registration number 41203-81-0, and the dimers are CAS registration number 42595-45-9.

### Component b)

The alkylated triaryl phosphate ester used herein can be selected from any alkylated triaryl phosphate ester. In preferred embodiments, the alkylated triaryl phosphate ester used herein is a mixture of isopropylated triphenyl phosphate esters. The alkylated triaryl phosphate ester can comprise in the range of from about 20 to about 50 wt. %, based on the total weight of the alkylated triaryl phosphate ester, isopropylphenyldiphenylphosphate, preferably in the range of from about 20 to about 40 wt. %, more preferably in the range of from about 30 to about 40 wt. %, on the same basis. The mixture alkylated triaryl phosphate ester can comprise in the range of from about 20 to about 40 wt. %, based on the total weight of the alkylated triaryl phosphate ester, di(isopropylphenylphenyl)phenylphosphate, preferably in the range of from about 20 to about 35 wt. %, more preferably in the range of from about 20 to about 30 wt. %, on the same basis. The alkylated triaryl phosphate ester can comprise in the range of from about 1 to about 15 wt. %, based on the total weight of the alkylated triaryl phosphate ester, tri(isopropylphenyl)phosphate, preferably in the range of from about 5 to about 15 wt. %, on the same basis. The alkylated triaryl phosphate ester used herein can comprise in the range of from about 0 to about 50 wt. %, triphenyl phosphate, based on the total weight of the alkylated triaryl phosphate ester, preferably, in the range of from about 10 to about 50 wt. %, more preferably in the range of from about 20 to about 40 wt. %, triphenyl phosphate, most preferably in the range of from about 20 to about 35 wt. %, triphenyl phosphate, all on the same basis. In an exemplary embodiment, the alkylated triaryl phosphate ester is a mixture of isopropylated triphenyl phosphate esters comprising at least two of, preferably at least three of, more preferably all of i) isopropyl phenyldiphenylphosphate; ii) di(isopropylphenylphenyl)phenylphosphate; iii) tri(isopropylphenyl)phosphate; and iv) triphenyl phosphate. In this particular embodiment, the amount of i) isopropylphenyldiphenylphosphate; ii) di(isopropylphenylphenyl)phenylphosphate; iii) tri(isopropylphenyl)phosphate; and iv) triphenyl phosphate in the mixture of isopropylated triphenyl phosphate esters is as described in this paragraph, including preferred embodiments, e.g., for i) isopropylphenyldiphenylphosphate, in the range of from about 20 to about 50 wt. %, based on the total weight of the alkylated triaryl phosphate ester, isopropylphenyldiphenylphosphate, preferably in the range of from about 20 to about 40 wt. %, etc. In this exemplary embodiment, all wt. % are based on the total weight of the mixture of isopropylated triphenyl phosphate esters.

### Use as a Flame Retardant

The flame retardant additives of the present are useful in providing flame retardancy to flexible polyurethane foams. Typically, the flame retardant additives will be included as one of various additives employed in the polyurethane foam formation process and will be employed using typical polyurethane foam formation conditions. Anyone unfamiliar with the art of forming flexible polyurethane foams may refer to, for example, Herrington and Hock, Flexible Polyurethane Foams, The Dow Chemical Company, 1991, 9.25 9.27 or Woods, G. Flexible Polyurethane Foams, Chemistry and Technology; Applied Science Publishers, London; 1982, 257 260.

Thus, in some embodiments, the present invention relates to a flexible polyurethane foam formulation comprising a flame retardant additive according to the present invention, typically a flame retarding amount of a flame retardant additive according to the present invention; at least one, in some embodiments only one, isocyanate, polyol or combination thereof; and at least one, in some embodiments only one, blowing agent, and flexible polyurethane foams, formed therefrom. Blowing agents suitable for use herein include water, a volatile hydrocarbon, halocarbon, or halohydrocarbon, or mixtures of two or more such materials.

By a flame retarding amount of the flame retardant additives of the present invention, it is meant that amount sufficient to meet or exceed the test standards set forth in California Technical Bulletin 117 part A and D. Generally, this is in the range of from about 5 to about 25 phr of the flame retardant additive. In preferred embodiments, a flame retarding amount is to be considered in the range of from about 5 to about 20 phr, more preferably in the range of from about 5 to about 15 phr, most preferably in the range of from about 10 to about 15 phr of the flame retardant additive.

The isocyanate used in the present invention can be selected from any of those known in the art to be effective in producing flexible polyurethane foams. The isocyanates suitable for use herein include any isocyanates that possess at least one free cyanate reactive group, most preferably two, although more may be utilized. In some embodiments, diisocyanates are used in the present inventions because these are well known components of polyurethane foams. The isocyanates used herein may also be aliphatic or aromatic in nature. Non-limiting examples of suitable aliphatic isocyanates include aliphatic diisocyanates useful in the present invention include: hexamethylene diisocyanate, tetramethylene diisocyanate, isophorone diisocyanate, (2,2,4) and (2,4,4)trimethylhexamethylene diisocyanate, and 4,4′-methylene bis(cyclohexyl isocyanate). The most prominently utilized isocyanates, and thus the most preferred types for this invention, are toluene diisocyanate (“TDI”), diphenylmethane diisocyanate (“MDI”), sometimes referred to as methylene diisocyanate, such as hexamethylene diisocyanate (“HDI) or isophorone diisocyanate (“IPDI”).

Polyols suitable for use herein can be selected from any polyols known in the art to be effective at producing flexible polyurethane foams. Thus, individual or mixtures of polyols with hydroxyl values in the range of up to about 150 KOH/g, and preferably in the range of from 0 to 100 mg KOH/g, more preferably in the range of from about 10 to about 100 KOH/g, can be used in the present inventions. In some embodiments, the polyol(s) is a polyether polyols.

In addition to these components, the flexible polyurethane foam formulations can contain any other component known in the art and used in the formation of rigid polyurethane foams. These other components are well known to those of ordinary skill in the art. For example, the flexible polyurethane foam formulations can contain 1) surfactants, ii) antioxidants, iii) diluents, iv) chain extenders or cross linkers, v) synergists, preferably melamine; and vi) plasticizers. These optional components are well known in the art and the amount of these optional components is conventional and not critical to the instant invention. For example, non-limiting examples of diluents such as low viscosity liquid C₁₋₄ halocarbon and/or halohydrocarbon diluents in which the halogen content is 1-4 bromine and/or chlorine atoms can also be included in the compositions of this invention. Non-limiting examples of such diluents include bromochloromethane, methylene chloride, ethylene dichloride, ethylene dibromide, isopropyl chloride, n-butyl bromide, sec-butyl bromide, n-butyl chloride, sec-butyl chloride, chloroform, perchloroethylene, methyl chloroform, and carbon tetrachloride.

It should be noted that these and other ingredients that can be used in the flexible polyurethane foam formulations of the present invention, and the proportions and manner in which they are used are reported in the literature.

In the practice of the present invention, the flexible polyurethane foam formulations can be combined with a catalyst, or the individual components combined in the presence of a catalyst, to form a flame retarded flexible polyurethane foam that meets or exceeds the test standards set forth in California Technical Bulletin 117 part A and D. Non-limiting examples of catalysts used for producing flexible polyurethane foams include amine catalysts, tin-based catalysts, bismuth-based catalysts or other organometallic catalysts, and the like.

The flexible foams of the present invention can be prepared according to any method known in the art. In some embodiments, the flexible polyurethane foams are prepared by the one-shot, the quasi- or semi-prepolymer or the prepolymer process. Further, the flexible polyurethane foams may be used to form articles such as molded foams, slabstock foams, and may be used as cushioning material in furniture and automotive seating, in mattresses, as carpet backing, as hydrophilic foam in diapers, and as packaging foam.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### EXAMPLES

In order to prove the effectiveness of a flame retardant according to the present invention, foams were prepared with and without a flame retardant according to the present invention. The flame retardant used in these examples was a mixture of about 10 wt. % of a commercially available cyclic phosphonate flame retardant sold under the tradename Amgard CU, and about 90 wt. % isopropyl diphenyl phosphate ester.

Foam Preparation: The polyol, surfactant, flame retardant, water and amine catalyst were weighed into a half-gallon container in the amounts indicated in Table 1, “php” is parts per hundred polyol. This “B” side was then pre-blended with a bow tie agitator at 2000 rpm for 60 seconds or until the mix was homogenous with no visible phase separation. Once mixed, the rpm's were reduced to 500, the timer was started and the blend was mixed for 40 seconds, at which time the TDI (isocyanate) was added. At 50 seconds, the stannous octoate (Kosmos 29) was added and mixing continued until cream time (reaction time) was noted. The mixture was then poured into a 14×14×14 cardboard box and rise time was recorded. Typical cream and rise times observed in this study, depending on density and index, were between 56-59 seconds for cream and 155-170 seconds for rise. Times are from the start of mixing to point of observation.

TABLE 1
Typical PU foam formulation*

| Components | Php |
|---|---|
| Polyether polyol - 3,000 m | 100 |
| (BASF 1388) | |
| Amine catalyst* | 0.07 |
| (Niax A1 - Momentive) | |
| Tin catalyst | 0.21-0.27 |
| (Kosmos 29 - Degussa) | |
| Surfactant | 1 |
| (B-8229 - Degussa) | |
| Water | 3.2-6.75 |
| Flame Retardant | 8-20 |
| TDI 80/20 (index 105-115) | 42-76 |

*The exact amount of each component used in a given formulation can be found in Table 2, below.

Flame Retardant Testing: In order to prove the effectiveness of a flame retardant according to the present invention, the flame retardant content of foams made by the process above were varied. Flammability testing was conducted in triplicate and results expressed as a percentage based on California's Technical Bulletin 117, parts A (vertical burn) and D (smolder). The Cal 117 requires 10 samples for burning, 5 before and 5 after ageing (104° C. for 24 hr). If one fails, from either set, then another 5 are burned from the failed set. Pass fail criteria is based on the following:
Average char length must not exceed 6 inches.
Maximum char length of any individual specimen must not exceed 8 inches.
Average after flame, including after flame of molten material must not exceed 5 seconds
Maximum after flame of any individual specimen must not exceed 10 inches.
   Based as a percentage, the test allows 2 failures per 20 samples, or a 90% overall rating as outlined by the above criteria.

TABLE 2
Cal 117 Performance (105 Index)

| | Formulation# 9113- | | | | | | | | | |
|---|---|---|---|---|---|---|---|---|---|---|
| | 11-04 | 11-01 | 11-02 | 11-03 | 15-02 | 15-03 | 15-04 | 18-01 | 18-02 | 18-03 |
| | Target Density, PCF | | | | | | | | | |
| | 1.1 | | | | 1.5 | | | 1.8 | | |
| Polyol, php | 100.00 | 100.00 | 100.00 | 100.00 | 100.00 | 100.00 | 100.00 | 100.00 | 100.00 | 100.00 |
| Surfactant, B-8229 | 1.00 | 1.00 | 1.00 | 1.00 | 1.00 | 1.00 | 1.00 | 1.00 | 1.00 | 1.00 |
| Water | 6.50 | 6.50 | 6.50 | 6.50 | 4.75 | 4.75 | 4.75 | 3.75 | 3.75 | 3.75 |
| Flame Retardant | 14.00 | 16.00 | 18.00 | 20.00 | 12.00 | 14.00 | 16.00 | 10.00 | 12.00 | 14.00 |
| Amine, A-1 | 0.07 | 0.07 | 0.07 | 0.07 | 0.07 | 0.07 | 0.07 | 0.07 | 0.07 | 0.07 |
| Tin, Kosmos 29 | 0.28 | 0.28 | 0.28 | 0.28 | 0.21 | 0.21 | 0.21 | 0.21 | 0.21 | 0.21 |
| TDI (Index 105) | 75.12 | 75.12 | 75.12 | 75.12 | 57.35 | 57.35 | 57.35 | 47.20 | 47.20 | 47.20 |
| Actual Density, pcf | 1.1 | 1.1 | 1.1 | 1.1 | 1.4 | 1.5 | 1.5 | 1.7 | 1.7 | 1.7 |
| Airflow, scfm | 1.7 | 3.1 | 1.3 | 3.2 | 3.5 | 2.9 | 3.0 | 2.5 | 2.6 | 2.5 |
| Unaged Cal 117 | | | | | | | | | | |
| Avg Char length, In | 6.8 ± 3.1 | 3.9 ± 0.4 | 3.6 ± 0.4 | 4.0 ± 1.7 | 5.0 ± 3.0 | 4.6 ± 1.4 | 3.7 ± 0.4 | 3.8 ± 1.3 | 3.7 ± 1.1 | 3.3 ± 1.2 |
| Avg After Flame, sec | 9.8 | 0.3 | 0.3 | 2.0 | 3.7 | 3.3 | 1.4 | 3.3 | 2.5 | 1.8 |
| Failures | 5 | 0 | 0 | 1 | 2 | 0 | 0 | 1 | 1 | 1 |
| Aged Cal 117 | | | | | | | | | | |
| Char Length, In | 7.3 ± 3.6 | 4.1 ± 1.3 | 3.7 ± 0.7 | 3.4 ± 0.3 | 4.6 ± 1.1 | 4.6 ± 2.0 | 4.2 ± 2.4 | 4.2 ± 1.7 | 2.6 ± 1.2 | 2.2 ± 0.9 |
| After Flame, sec | 10.5 | 1.1 | 0.1 | 0.0 | 4.6 | 4.0 | 3.7 | 4.2 | 2.1 | 1.1 |
| Failures | 4 | 0 | 0 | 0 | 1 | 2 | 1 | 2 | 1 | 1 |
| Cal 117 pass % | 70.0% | 100.0% | 100.0% | 96.7% | 90.0% | 93.3% | 96.7% | 90.0% | 93.3% | 93.3% |
| Smolder, % wt retained | | | | | | | | | | |
| A | 99.4% | 99.5% | 97.3% | 99.7% | 91.9% | 88.1% | 95.6% | 96.0% | 95.0% | 93.4% |
| B | 99.8% | 99.6% | 99.8% | 99.1% | 91.3% | 84.8% | 93.3% | 92.1% | 88.4% | 95.7% |
| C | 99.1% | 99.6% | 99.5% | 99.5% | 89.9% | 83.4% | 91.9% | 85.9% | 91.9% | 97.2% |
| Tensile Strength, PSI | | 19.0 | | | | 19.0 | | | 18.7 | |
| % Strength at Break | | 152.2 | | | | 168.9 | | | 159.4 | |
| Tear Resistance, lb/in | | 2.8 | | | | 2.7 | | | 2.4 | |
| Yellowness Index | 0 | 0 | 0 | 0 | 0 | 0 | 0 | 0 | 0 | 0 |

1. A flame retardant additive suitable for use in polyurethane foams comprising:
a) at least one cyclic phosphonate flame retardant;
b) at least one alkylated triaryl phosphate ester,
wherein a) is present in an amount of less than about 30 wt. %, based on the total weight of the flame retardant additive and b) is present in an amount of greater than about 70 wt. %, based on the total weight of the flame retardant additive.

2. (canceled)

3. The flame retardant additive according to claim 1 wherein the cyclic phosphonate contains in the range of from about 50 to about 70 wt. % monomer and in the range of from about 15 to about 25 wt. % dimer, both based on the total weight of the cyclic phosphonate.

4. The flame retardant additive according to any of claims 1 wherein the alkylated triaryl phosphate ester is a mixture of isopropylated triphenyl phosphate esters comprising at least one of: i) isopropylphenyldiphenylphosphate; ii) di(isopropylphenyl)phenylphosphate; iii) tri(isopropylphenyl)phosphate; and iv) triphenyl phosphate.

5. (canceled)

6. The flame retardant additive according to claim 3 wherein the monomers are CAS registration number 41203-81-0, and the dimers are CAS registration number 42595-45-9.

7. The flame retardant additive according to claim 1 wherein said flame retardant additive contains i) in the range of from about 5 to about 30 wt. % of a) and in the range of from about 70 to about 95 wt. % of b); or ii) in the range of from about 5 to about 15 wt. % of a) and in the range of from about 85 to about 95 wt. % of b), all based on the total weight of a) and b).

8-9. (canceled)

10. A flexible polyurethane foam derived from at least one isocyanate, polyol, or mixture thereof; at least one blowing agent; and a flame retardant additive wherein said flame retardant additive contains:
a) at least one cyclic phosphonate flame retardant;
b) at least one, alkylated triaryl phosphate ester, and optionally
c) one or more i) surfactants, ii) antioxidants, iii) diluents, iv) chain extenders or cross linkers, v) synergists; and vi) plasticizers,
wherein a) is present in an amount of less than about 30 wt. %, based on the total weight of a) and b), and b) is present in an amount of greater than about 70 wt. %, based on the total weight of a) and b), and wherein the flexible polyurethane foam meets or exceeds the requirements of California Technical Bulletin 117 part A and D.

11. (canceled)

12. The flexible polyurethane foam according to claim 10 wherein the cyclic phosphonate contains in the range of from about 50 to about 70 wt. % monomer and in the range of from about 15 to about 25 wt. % dimer, both based on the total weight of the cyclic phosphonate.

13. The flexible polyurethane foam according to claim 10 wherein the alkylated triaryl phosphate ester is a mixture of isopropylated triphenyl phosphate esters comprising at least one of: i) isopropylphenyldiphenylphosphate; ii) di(isopropylphenyl)phenylphosphate; iii) tri(isopropylphenyl)phosphate; and iv) triphenyl phosphate.

14. (canceled)

15. The flexible polyurethane foam according to claim 12 wherein the monomers are CAS registration number 41203-81-0, and the dimers are CAS registration number 42595-45-9.

16-18. (canceled)

19. A process for forming a flame retarded polyurethane foam comprising combining or bringing together:
a) at least one at least one cyclic phosphonate flame retardant;
b) at least one, alkylated triaryl phosphate ester;
c) at least one isocyanate, polyol, or mixture thereof;
d) at least one blowing agent; and
optionally
e) one or more i) surfactants, ii) antioxidants, iii) diluents, iv) chain extenders or cross linkers, v) synergists; and vi) plasticizers,
thereby forming a flame retarded polyurethane foam,
wherein a) is present in an amount of less than about 30 wt. %, based on the total weight of a) and b), and b) is present in an amount of greater than about 70 wt. %, based on the total weight of a) and b); a)-d), and optionally e), are combined in the presence of at least one catalyst; and the flame retarded flexible polyurethane foam thus formed meets or exceeds the requirements of California Technical Bulletin 117 part A and D.

20. (canceled)

21. The process according to claim 19 wherein the cyclic phosphonate contains in the range of from about 50 to about 70 wt. % monomer and in the range of from about 15 to about 25 wt. % dimer, both based on the total weight of the cyclic phosphonate.

22. The process according to claim 19 wherein the alkylated triaryl phosphate ester is a mixture of isopropylated triphenyl phosphate esters comprising at least one of: i) isopropylphenyldiphenylphosphate; ii) di(isopropylphenyl)phenylphosphate; iii) tri(isopropylphenyl)phosphate; and iv) triphenyl phosphate.

23. (canceled)

24. The process according to claim 21 wherein the monomers are CAS registration number 41203-81-0, and the dimers are CAS registration number 42595-45-9.

25. The process according to claim 19 wherein i) a) is present in an amount in the range of from about 5 to about 30 wt. % and b) a) is present in an amount in the range of from about 70 to about 95 wt. % of b); or ii) a) is present in an amount in the range of from about 5 to about 15 wt. % and b) is present in an amount in the range of from about 85 to about 95 wt. %, all based on the total weight of a) and b).

26-27. (canceled)

28. The process according to claim 19 wherein a) is present in an amount in the range of from about 5 to about 25 phr.

29. A molded or extruded article made from the flame retarded polyurethane foam according to claim 19.
